(19) United States
(12) Patent Application Publication
(10) Pub. No.: US 2006/0277339 A1
(43) Pub. Date: Dec. 7, 2006

(54) Communication apparatus, switching method, and switching program

(76) Inventors: Seiji Sakaki, Osaka (JP); Shigeyuki Ochiai, Osaka (JP)

Correspondence Address: MCDERMOTT WILL & EMERY LLP, 600 13TH STREET, N.W., WASHINGTON, DC, 20005-3096, US

(21) Appl. No.: 11/447,867

(22) Filed: Jun. 7, 2006

(30) Foreign Application Priority Data
Jun. 7, 2005 (JP) 2005-166701

(51) Int. Cl. G06F 13/38

(52) U.S. Cl. 710/62

(57) ABSTRACT

To provide a communication apparatus which selectively performs a data transfer by differential signaling and a data transfer by single-ended signaling using a USB cable, where a USB host in the communication apparatus can recognize USB connection even when differential signaling is switched to single-ended signaling. The communication apparatus performs the data transfer by differential signaling using two data transfer signal lines in the USB cable, and the data transfer by single-ended signaling using one of the two data transfer signal lines. The communication apparatus includes a NAK circuit which, when differential signaling is switched to single-ended signaling, outputs a NAK response to the USB host to have the USB host recognize the USB connection.

### BACKGROUND OF THE INVENTION

1. Field of the Invention

The present invention relates to a communication apparatus that performs data transfers using a USB (Universal Serial Bus) cable.

2. Related Art

A data transfer using a USB cable is conducted in the following manner. When a device is connected to a host, the host detects the connection, and performs initialization such as assigning an address to the connected device, to enable a data transfer between the host and the device. After this, the data transfer is performed according to differential signaling. Differential signaling is a method of transferring data one bit at a time using two signal lines. In differential signaling, one signal line carries data of one phase, the other signal line carries data of an opposite phase, and the receiving end reads a difference in potential between the two signal lines as a signal value. Here, the difference takes one of two values. If the difference is large, the signal value is “1”. If the difference is small, the signal value is “0”. Differential signaling is suitable for transmission of a large quantity of data.

There is another data transfer method called single-ended signaling (serial transfer method). Single-ended signaling is a method of transferring data one bit at a time using one signal line. In single-ended signaling, one signal line carries data that expresses “1” or “0” by a voltage level. When compared with differential signaling, single-ended signaling is suitable for transmission of audio data and the like.

Differential signaling and single-ended signaling have their own advantages and disadvantages depending on the type of data to be transmitted. Hence it is desirable for the host and the device connected to the host, to support both data transfer methods. This can be achieved by installing both a connection port compatible with differential signaling and a connection port compatible with single-ended signaling.

Japanese Patent Application Publication No. 2000-194444 discloses a communication apparatus that includes a plurality of ports so as to be capable of transferring data in and out using different data transfer methods.

In a small appliance such as a portable terminal (e.g. a PDA), however, it is difficult to install the two ports due to a limited installation space. In view of this, a technique of supporting both data transfer methods by sharing a port and a cable has been proposed.

In this technique, a data transfer by single-ended signaling is performed using one of the two signal lines provided for differential signaling. By sharing the signal line, it becomes unnecessary to install the connection port for single-ended signaling. This is an effective technique especially for a small appliance such as a mobile phone that has only a limited space for installation of connection ports.

This technique however, has the following problem. In a USB protocol, a communication apparatus recognizes USB connection with an external device connected to it, by receiving a predetermined signal prescribed by the USB protocol from the external device via the two signal lines. The USB connection referred to here is such a connection state that is established as a result of the communication apparatus recognizing the connection of the external device and performing the initialization such as address assignment.

According to the above technique of supporting both data transfer methods by sharing the USB cable, it is impossible for the communication apparatus to recognize the USB connection using both of the two signal lines while single-ended signaling is being executed using one of the two signal lines. This misleads the communication apparatus into recognizing that the external device has been disconnected. Therefore, to conduct a data transfer by differential signaling after completing a data transfer by single-ended signaling, the communication apparatus performs the initialization all over again. Especially when a data transfer by differential signaling is interrupted by a data transfer by single-ended signaling, data which was in the middle of transmission at the time of interrupt may be stopped halfway. In such a case, the communication apparatus resumes the data transfer by differential signaling, by retransmitting the data that was stopped due to the interrupt. The need to perform, before this retransmission, the initialization again to reestablish the USB connection with the external device involves a great deal of inconvenience.

### SUMMARY OF THE INVENTION

The present invention was conceived in view of the above problem, and aims to provide a communication apparatus that is capable of transferring data in and out by switching differential signaling and single-ended signaling, while recognizing the USB connection.

The stated aim can be achieved by a communication apparatus that performs data transfers with an external device connected thereto by a plurality of signal lines, including: a differential signaling generation unit operable to recognize a predetermined connection state with the external device by receiving a predetermined signal from the external device via two out of the plurality of signal lines, and generate data to be transmitted by differential signaling that uses the two signal lines; a single-ended signaling generation unit operable to generate data to be transmitted by single-ended signaling that uses one of the two signal lines; a switching-transmission unit operable to switch a data transfer method between the differential signaling and the single-ended signaling, and transmit a corresponding one of the data generated by the differential signaling generation unit and the data generated by the single-ended signaling generation unit to the external device by the data transfer method; and a substitute signal output unit operable to, when the switching-transmission unit switches the data transfer method from the differential signaling to the single-ended signaling, output a substitute signal of the predetermined signal to the differential signaling generation unit to have the predetermined connection state recognized.

According to this construction, the differential signaling generation unit receives the substitute signal from the circuit in the communication apparatus. This enables the differential signaling generation unit to recognize the predetermined connection state with the external device, even when the differential signaling generation unit ceases receiving the predetermined signal from the external device via the two signal lines as a result of switching from differential signaling to single-ended signaling.

Here, the differential signaling generation unit may operate in accordance with a USB protocol, wherein the substitute signal is a NAK response in the USB protocol.

According to this construction, the communication apparatus generates the NAK response to keep the predetermined connection state recognized.

In the USB protocol, the communication apparatus recognizes the USB connection with the external device, by receiving an idle signal from the external device via the two signal lines. During data transmission, the communication apparatus also recognizes the USB connection with the external device as well as confirming a data transfer success/failure, by receiving, for each transmitted data packet, an ACK response indicating a data reception success or a NAK response indicating a data reception failure from the external device via the two signal lines.

Here, the communication apparatus may further include: a reception unit operable to receive data from the external device via the signal line or the two signal lines.

According to this construction, the communication apparatus can receive data from the external device. Since the same signal lines are used for data transmission and reception, signal line installation costs can be reduced.

Here, the switching-transmission unit may include: a switching signal generation unit operable to generate a switching signal for requesting to switch the data transfer method from the differential signaling to the single-ended signaling; and a switching signal transmission unit operable to transmit the switching signal to the external device.

According to this construction, the communication apparatus can switch the data transfer method in sync with the external device, with it being possible to conduct data transfers smoothly.

Here, the communication apparatus may further include: a timer unit operable to count a time, wherein the switching-transmission unit switches the data transfer method whenever a predetermined time is counted by the timer unit.

According to this construction, the communication apparatus switches the data transfer method at predetermined time intervals. This makes it unnecessary for the communication apparatus to perform synchronization with the external device, with it being possible to conduct data transfers smoothly.

Here, the switching-transmission unit may include: a stop unit operable to, when switching the data transfer method from the differential signaling to the single-ended signaling, have the differential signaling generation unit stop the data generation until the transmission of the data by the single-ended signaling ends.

According to this construction, the differential signaling generation unit is prohibited from generating data while single-ended signaling is being executed. As a result, unnecessary data generation by the differential signaling generation unit can be avoided. In this case, the switching-transmission unit needs only to manage the data generated by the single-ended signaling generation method, which alleviates a load on the switching-transmission unit.

Here, if the transmission of the data by the differential signaling is interrupted by switching the data transfer method from the differential signaling to the single-ended signaling, the switching-transmission unit may resume, when switching from the single-ended signaling back to the differential signaling, the transmission of the data by the differential signaling by retransmitting a piece of data which was in a middle of transmission when switching from the differential signaling to the single-ended signaling and for which the NAK response was output.

According to this construction, the data which was in the middle of transmission when switching from differential signaling to single-ended signaling is retransmitted to enhance the data transmission reliability.

Depending on when differential signaling is switched to single-ended signaling, the data which was being transmitted by differential signaling may not have been correctly received by the external device. In such a case, when switching single-ended signaling back to differential signaling, the data needs to be retransmitted to ensure that the external device obtains the data. As mentioned earlier, the NAK response indicates a data reception failure. This being so, upon receiving the NAK response, the differential signaling generation unit recognizes that the transmission of the data to the external device has failed, and accordingly retransmits the data. Thus, the data transmission is performed without making particular settings for the data transmission.

Here, the plurality of signal lines may include, in addition to the two signal lines, a synchronous signal line for synchronizing the switching of the data transfer method with the external device, wherein the communication apparatus further includes: a setting unit operable to set the synchronous signal line to a first potential, to request the external device to switch the data transfer method; and a detection unit operable to detect that the external device has switched the data transfer method and is ready for data reception by the data transfer method, when the first potential of the synchronous signal line is changed to a second potential by the external device, and the switching-transmission unit switches the data transfer method and transmits the corresponding data to the external device, after the detection unit detects that the external device has switched the data transfer method and is ready for data reception by the data transfer method.

According to this construction, the communication apparatus can determine the timing to switch the data transfer method with the external device.

The stated aim can also be achieved by a switching method used in a communication apparatus to switch a data transfer method, including: a differential signaling generation step of recognizing a predetermined connection state with an external device connected to the communication apparatus by receiving a predetermined signal from the external device via two signal lines, and generating data to be transmitted by differential signaling that uses the two signal lines; a single-ended signaling generation step of generating data to be transmitted by single-ended signaling that uses one of the two signal lines; a switching-transmission step of switching the data transfer method between the differential signaling and the single-ended signaling, and transmitting a corresponding one of the data generated in the differential signaling generation step and the data generated in the single-ended signaling generation step to the external device by the data transfer method; and a substitute signal generation step of, when the switching-transmission step switches the data transfer method from the differential signaling to the single-ended signaling, generating a substitute signal of the predetermined signal to have the predetermined connection state recognized.

The stated aim can also be achieved by a switching program used in a computer of a communication apparatus to execute a process of switching a data transfer method, the process including: a differential signaling generation step of recognizing a predetermined connection state with an external device connected to the communication apparatus by receiving a predetermined signal from the external device via two signal lines, and generating data to be transmitted by differential signaling that uses the two signal lines; a single-ended signaling generation step of generating data to be transmitted by single-ended signaling that uses one of the two signal lines; a switching-transmission step of switching the data transfer method between the differential signaling and the single-ended signaling, and transmitting a corresponding one of the data generated in the differential signaling generation step and the data generated in the single-ended signaling generation step to the external device by the data transfer method; and a substitute signal generation step of, when the switching-transmission step switches the data transfer method from the differential signaling to the single-ended signaling, generating a substitute signal of the predetermined signal to have the predetermined connection state recognized.

According to this method and program, the predetermined connection state can be recognized even when the data transfer method is switched from differential signaling to single-ended signaling.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a functional block diagram showing a communication apparatus and another communication apparatus connected to it, according to a first embodiment of the present invention;

FIG. 2 is a flowchart showing an operation of the communication apparatus shown in FIG. 1;

FIG. 3 is a flowchart showing an initialization operation performed when the other communication apparatus is connected to the communication apparatus;

FIG. 4 is a functional block diagram showing a communication apparatus according to a second embodiment of the present invention;

FIG. 5 is a graph showing a transition of a potential of a synchronous signal line in the second embodiment;

FIG. 6 is a flowchart showing an operation of the communication apparatus shown in FIG. 4;

FIG. 7 is a flowchart showing a synchronization operation of the communication apparatus shown in FIG. 4 as a host in the second embodiment; and

FIG. 8 is a flowchart showing a synchronization operation of a device in the second embodiment.

### DESCRIPTION OF THE PREFERRED EMBODIMENT(S)

### First Embodiment

The following describes a communication apparatus according to a first embodiment of the present invention, with reference to drawings.

<Construction>

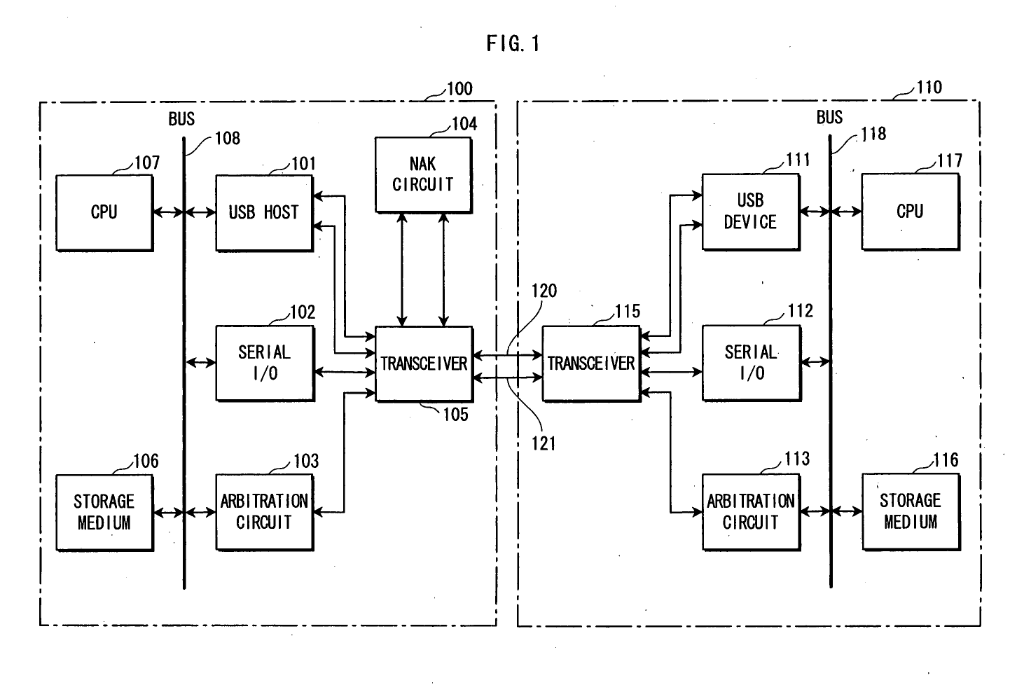

FIG. 1 shows an example system in which a communication apparatus 100 of the first embodiment is connected with another communication apparatus 110. The communication apparatus 100 serves as a host, and transfers data with the communication apparatus 110 connected to it. The host referred to here has functions of managing address assignment, data transfer timing, and the like with respect to the communication apparatus 110. Meanwhile, the communication apparatus 110 serves as a device.

The communication apparatus 100 includes a USB host 101, a serial I/O 102, an arbitration circuit 103, a NAK circuit 104, a transceiver 105, a storage medium 106, a CPU 107, and a bus 108. The communication apparatus 110 includes a USB device 111, a serial I/O 112, an arbitration circuit 113, a transceiver 115, a storage medium 116, a CPU 117, and a bus 118. The communication apparatuses 100 and 110 are connected to each other by a USB cable which includes a D+signal line 120 and a D-signal line 121. The D+signal line 120 and the D-signal line 121 are two signal lines used for a data transfer according to differential signaling. In addition to these signal lines, the USB cable also includes a power supply signal line and a ground signal line (not illustrated). Thus, the USB cable is made up of a total of four signal lines. In single-ended signaling, the D+signal line 120 is used for a data transfer.

The USB host 101 operates in accordance with the USB protocol. The USB host 101 has a function of generating differential signaling data which is to be fed to the two signal lines according to differential signaling, from data output from the storage medium 106 under control of the CPU 107. In detail, the USB host 101 feeds data that expresses “0” or “1” by a voltage level (e.g. 100 mV and 300 mV) to the D+signal line 120, and data of an opposite phase to the D-signal line 121. The USB device 111 in the communication apparatus 110 reads a difference in potential between the D+signal line 120 and the D-signal line 121, and recognizes the value “1” if the difference is large, and the value “0” if the difference is small.

The USB host 101 also has a function of receiving differential signaling data transmitted from the communication apparatus 110 via the transceiver 115, and a function of recognizing the connection with the communication apparatus 110 by a potential transmitted via the two signal lines. In detail, the USB host 101 recognizes the connection upon detecting that an idle state continues 2 msec or longer, in accordance with the USB protocol. In the USB protocol, the idle state has two patterns depending on whether a data transfer speed is Low Speed or Full Speed. In the case of Low Speed, the idle state is a state where the communication apparatus 100 receives a lower potential than a LOW potential used for data transfers via the D+signal line 120 and a higher potential than a HIGH potential used for data transfers via the D-signal line 121, from the communication apparatus 110. In the case of Full Speed, the idle state is a state where the communication apparatus 100 receives a higher potential than the HIGH potential used for data transfers via the D+signal line 120 and a lower potential than the LOW potential used for data transfers via the D-signal line 121, from the communication apparatus 110. Note here that Low Speed is 1.5 Mbps and Full Speed is 12 Mbps.

The USB host 101 also has a function of recognizing the connection, by receiving one of an ACK response and a NAK response that respectively indicate a success and failure of data reception.

The USB host 101 includes a signal conversion circuit for converting single-ended signaling data to differential signaling data to be fed to the two signal lines, and converting differential signaling data received via the two signal lines to single-ended signaling data.

The USB host 101 further has a function of performing, when the communication apparatus 110 is connected to the communication apparatus 100, initialization such as address assignment that is necessary for initiating a data transfer with the communication apparatus 110. Here, an address is assigned so that the USB host 101 can perform correct data communications with the communication apparatus 110.

The serial I/O 102 has a function of generating single-ended signaling data to be fed to one signal line according to single-ended signaling, from data output from the storage medium 106 under control of the CPU 107. In detail, the serial I/O 102 generates a signal that expresses “0” or “1” by a voltage level (e.g. 0 V and 3 V). The serial I/O 102 also has a function of receiving single-ended signaling data transmitted from the communication apparatus 110 via the transceiver 105.

The arbitration circuit 103 has a function of requesting the transceiver 105 to switch transmission between the data generated by the USB host 101 and the data generated by the serial I/O 102. In detail, upon detecting data generation by the serial I/O 120, the arbitration circuit 103 outputs a request to switch from differential signaling to single-ended signaling to the transceiver 105.

The NAK circuit 104 has a function of generating a data signal which corresponds to a NAK response indicating a data reception failure, and outputting the data signal to the transceiver 105 via two signal lines connecting the NAK circuit 104 and the transceiver 105, according to an instruction by the transceiver 105. In the USB protocol, data subjected to transmission is divided into data blocks that are a unit of data transmittable in 1 msec, and the data blocks are transmitted one by one. During the data transmission, the USB host 101 recognizes the connection with the communication apparatus 110, by receiving an ACK response indicating a data reception success or a NAK response indicating a data reception failure for each data block. The NAK response is 4-bit data transmitted by differential signaling using the two signal lines. Once a data transfer by single-ended signaling has been completed and the transceiver 105 has switched from single-ended signaling back to differential signaling, the NAK circuit 104 stops the generation and output of the NAK response according to an instruction by the transceiver 105. Note here that a NAK response is originally used in such a manner that the communication apparatus 110 generates a NAK response and transmits it to the communication apparatus 100 upon a data reception failure.

The transceiver 105 has a function of transmitting the data generated by the USB host 101 and the data generated by the serial I/O 102, to the communication apparatus 110. This transmission is performed by switching the data transfer method under control of the arbitration circuit 103. The transceiver 105 also has a function of receiving data from the communication apparatus 110, and outputting the received data to the USB host 101 or the serial I/O 102 depending on a data type. To the USB host 101, the transceiver 105 directly outputs the data received from the communication apparatus 110, via the two signal lines connecting the transceiver 105 and the USB host 101.

The transceiver 105 also has a function of outputting an instruction to generate a NAK response to the NAK circuit 104, upon receiving a request to switch from differential signaling to single-ended signaling from the arbitration circuit 103. The generation of the NAK response is started immediately before the switching from differential signaling to single-ended signaling. The transceiver 105 also has a function of passing the NAK response output from the NAK circuit 104 to the USB host 101 via the two signal lines. As a result, the NAK response generated by the NAK circuit 104 is sent to the USB host 101 via the two signal lines while a data transfer by single-ended signaling is being performed. The transceiver 105 also has a function of instructing the NAK circuit 104 to stop the generation of the NAK response when the data transfer by single-ended signaling ends.

The storage medium 106 is realized by a hard disk device or the like, and stores various data. The storage medium 106 has a function of outputting stored data to the USB host 101 or the serial I/O 102 under control of the CPU 107. The storage medium 106 also has a function of receiving data which the USB host 101 or the serial I/O 102 has received from the transceiver 105, and stores the received data.

The CPU 107 has a function of controlling each construction element in the communication apparatus 100 through the bus 108. The CPU 107 also has a function of controlling each construction element to output data to the communication apparatus 110 or receive data from the communication apparatus 110 according to a user instruction. The CPU 107 also has a function of judging which data transfer method is to be used depending on a data type, and having the USB host 101 or the serial I/O 102 generate data based on the judgment. A data transfer method corresponding to each data type has been determined in advance. For instance, the CPU 107 has the USB host 101 generate data in the case of transmission of a large quantity of data, and has the serial I/O 102 generate data in the case of transmission of real-time audio data.

The construction elements of the communication apparatus 110 except the USB device 111 have the same functions as those of the communication apparatus 100 with the same names, and so their explanation has been omitted here. The following explains the USB device 111.

The USB device 111 basically has the same functions as the USB host 101, but operates under control of the USB host 101. The USB device 111 has a function of receiving data or transmitting data according to a request by the USB host 101. The USB device 111 does not have a function of performing address assignment and the like on a device connected to it, unlike the USB host 101. Which is to say, the communication apparatus 110 as a device performs data transmission/reception according to a request by the communication apparatus 100 as a host.

<Operation>

The following describes operations of the communication apparatus 100 in the first embodiment.

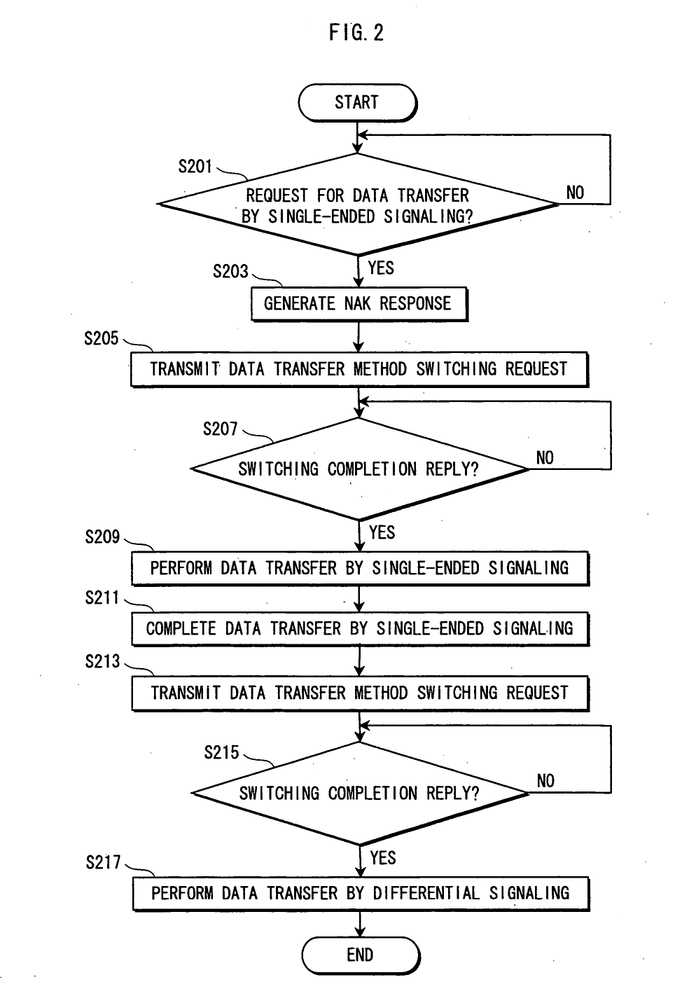

First, an operation of the communication apparatus 100 in the case of switching from differential signaling to single-ended signaling is explained below, with reference to a flowchart of FIG. 2.

Suppose the communication apparatus 100 is transmitting data generated by the USB host 101, to the communication apparatus 110 via the transceiver 105 using the D+signal line 120 and the D-signal line 121. During the transmission, when a request to perform a data transfer by single-ended signaling occurs, that is, when data is generated by the serial I/O 102 (step S201), the arbitration circuit 103 outputs a request to switch from differential signaling to single-ended signaling to the transceiver 105. Upon receiving this request, the transceiver 105 instructs the NAK circuit 104 to generate a NAK response (step S203), receives the NAK response from the NAK circuit 104, and outputs the NAK response to the USB host 101.

The transceiver 105 then performs synchronization with the communication apparatus 110 to switch from differential signaling to single-ended signaling. The transceiver 105 recognizes an idle state, that is, a state where no data transfer is being performed, through the D+signal line 120 and the D-signal line 121. The transceiver 105 then outputs a request to switch from differential signaling to single-ended signaling to the communication apparatus 110, using a predetermined signal that is not used in the current USB protocol (step S205). If the idle state cannot be recognized, the transceiver 105 waits for the idle state. The idle state has been explained earlier.

When the communication apparatus 110 is ready for data reception by single-ended signaling, the communication apparatus 110 outputs a data reception ready signal via the two signal lines. Upon detecting the data reception ready signal (step S207), the communication apparatus 100 transmits the data generated by the serial I/O 102 to the communication apparatus 110 via the transceiver 105 using the D+signal line 120 (step S209).

After completing the data transfer by single-ended signaling (step S211), the communication apparatus 100 performs synchronization with the communication apparatus 110 to resume the data transfer by differential signaling. Since the data transfer by single-ended signaling has been performed, the communication apparatus 100 issues a request to switch from single-ended signaling back to differential signaling, by transmitting a signal of a predetermined waveform to the communication apparatus 110 (step S213). Upon receiving a signal indicating that the data transfer method has been switched in response to this request (step S215: YES), the transceiver 105 instructs the NAK circuit 104 to stop generating the NAK response.

Having stopped receiving the NAK response, the USB host 101 regenerates data for which the NAK response has been received, and outputs the regenerated data to the transceiver 105. The USB host 101 also generates subsequent data and outputs the subsequent data to the transceiver 105. The transceiver 105 sequentially transmits the data which was in the middle of transmission when switching from differential signaling to single-ended signaling and the subsequent data, to the communication apparatus 110 (step S217).

An initialization operation performed by the communication apparatus 100 on a device, such as the communication apparatus 110, which is connected to the communication apparatus 100 is explained next.

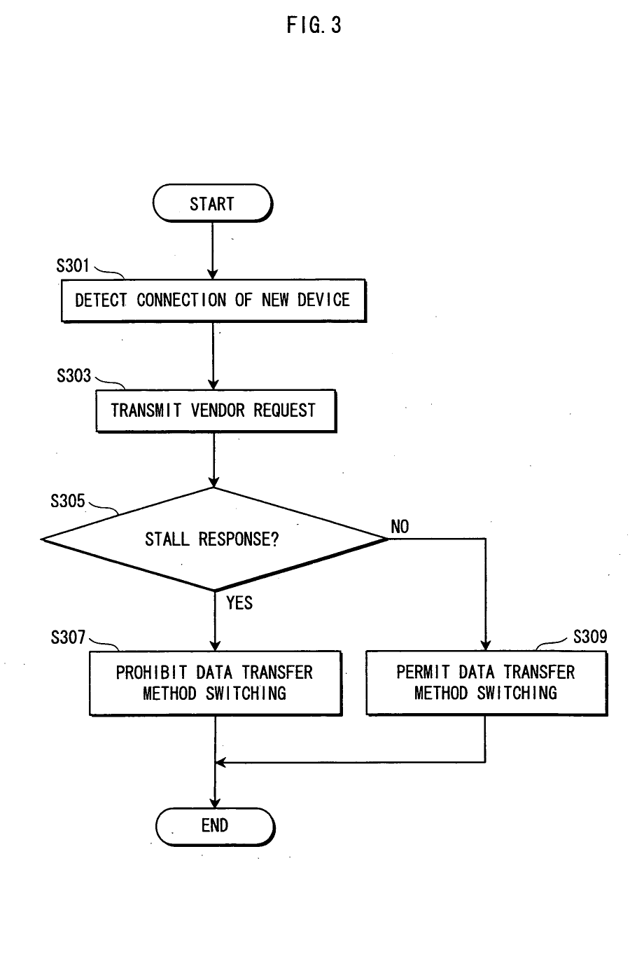

There may be cases where a device connected to the communication apparatus 100 does not support data transfer method switching. By prohibiting data transfer method switching for such a device, a load on the communication apparatus 100 can be reduced. The initialization operation which serves this purpose is shown in a flowchart of FIG. 3.

The transceiver 105 detects that a new device has been connected to the communication apparatus 100, upon receiving a predetermined signal according to the USB protocol from the device connected to a port of the communication apparatus 100 via the USB cable (step S301). The transceiver 105 performs initialization such as address assignment on the connected device, and judges whether the connected device is capable of switching between differential signaling and single-ended signaling. This judgment is made using a vendor request (step S303). The vendor request is a unique instruction that is obtained by a products company or the like from the USB Implementers Forum. In this example, the vendor request is a signal for checking whether data transfer method switching is possible or not.

If the connected device does not meet the vendor request, the connected device returns a STALL response in accordance with the USB protocol (step S305). The STALL response is 4-bit data. The STALL response indicates that the connected device cannot meet the vendor request, that is, the connected device is incapable of data transfer method switching.

If the STALL response is not returned from the connected device in response to the vendor request, the transceiver 105 judges that the connected device is capable of data transfer method switching, and permits the arbitration circuit 103 to perform data transfer method switching (step S309). If the STALL response is returned from the connected device, on the other hand, the transceiver 105 judges that the connected device is incapable of data transfer method switching, and prohibits the arbitration circuit 103 to perform data transfer method switching (step S307).

This completes the initialization operation of the communication apparatus 100 on the connected device, as a result of which data transfers are enabled.

### Second Embodiment

A second embodiment of the present invention relates to another method of switching between differential signaling and single-ended signaling by a host and a device connected to the host.

The following describes a communication apparatus according to the second embodiment of the present invention, with reference to drawings.

<Construction>

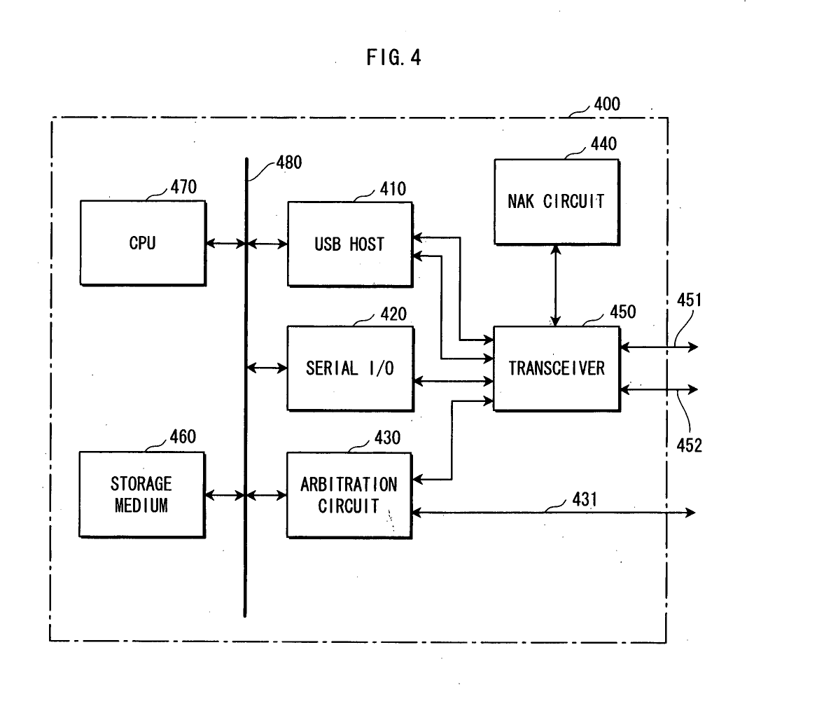

FIG. 4 is a functional block diagram showing a construction of a communication apparatus 400 of the second embodiment.

In the drawing, the communication apparatus 400 includes a USB host 410, a serial I/O 420, an arbitration circuit 430, a NAK circuit 440, a transceiver 450, a storage medium 460, a CPU 470, and a bus 480. The communication apparatus 400 basically has a same construction as the communication apparatus 100 in the first embodiment. The difference from the first embodiment lies in that a synchronous port is newly included in the communication apparatus 400 to synchronize switching with a device connected to it. As a result, the USB cable includes one more signal line, i.e., a synchronous signal line 431, in addition to four signal lines that are signal lines 451 and 452 for data transfers, a power supply signal line, and a ground signal line.

The synchronous signal line 431 is shielded in the USB cable together with the other signal lines, and connected to the arbitration circuit 430. The arbitration circuit 430 has a function of reading and setting a potential of the synchronous signal line 431. The same applies to an arbitration circuit in the device connected to the communication apparatus 400.

Also, the transceiver 450 has a function of temporarily stopping data generation by the USB host 410 during a data transfer by single-ended signaling.

<Operation>

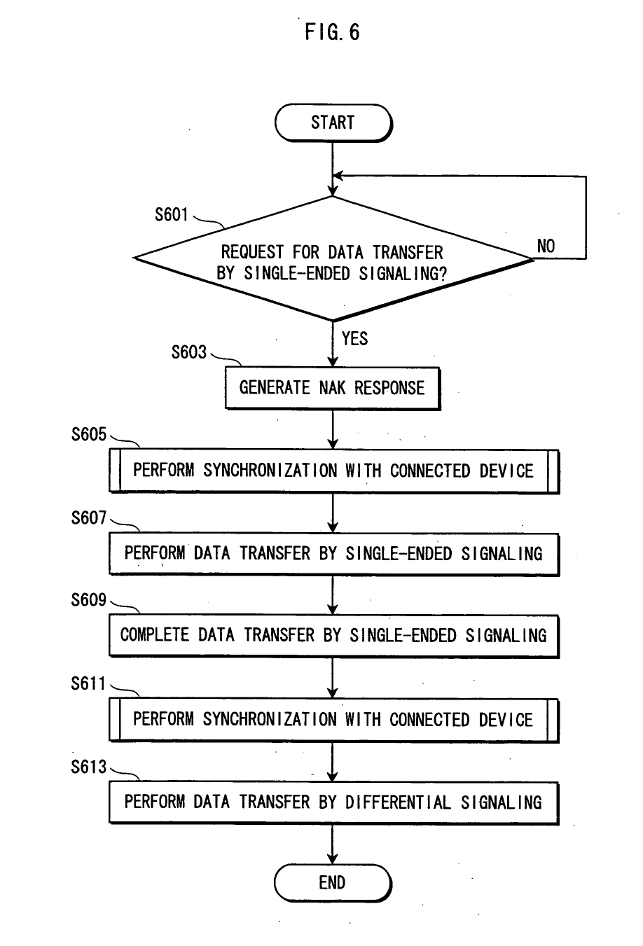

An operation of the communication apparatus 400 as a host is explained below, with reference to a flowchart of FIG. 6.

Suppose the communication apparatus 400 is transmitting data generated by the USB host 410 to the device connected to it, via the transceiver 450. During the transmission, when a request to perform a data transfer by single-ended signaling occurs, that is, when data is generated by the serial I/O 420 (step S601: YES), the arbitration circuit 430 outputs a request to switch from differential signaling to single-ended signaling to the transceiver 450. Otherwise (step S601: NO), the communication apparatus 400 continues to sequentially transmit the data generated by the USB host 410. Upon receiving the switching request, the transceiver 450 instructs the NAK circuit 440 to generate a NAK response (step S603), receives the NAK response from the NAK circuit 440, and outputs the NAK response to the USB host 410. The transceiver 450 also has the USB host 410 temporarily stop the data generation. After this, the transceiver 450 instructs the NAK circuit 440 to stop the generation of the NAK response. Here, the USB host 410 retains data for which the NAK response has been received.

The arbitration circuit 430 performs synchronization with the connected device, to switch from differential signaling to single-ended signaling using the synchronous signal line 431 (step S605).

Once the synchronization has been completed and the connected device is ready for data reception by single-ended signaling, the communication apparatus 400 transmits the data generated by the serial I/O 420 to the connected device via the transceiver 450 (step S607).

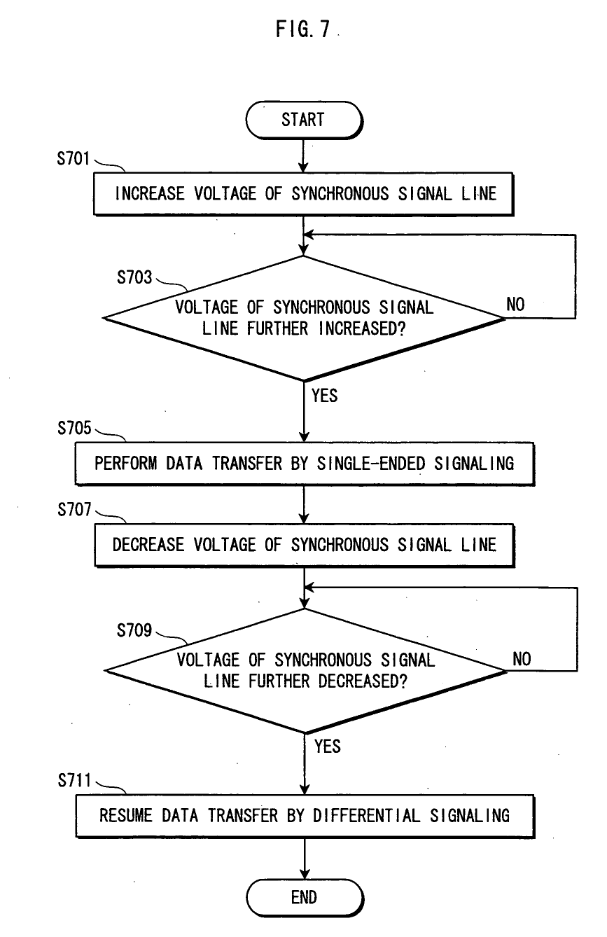

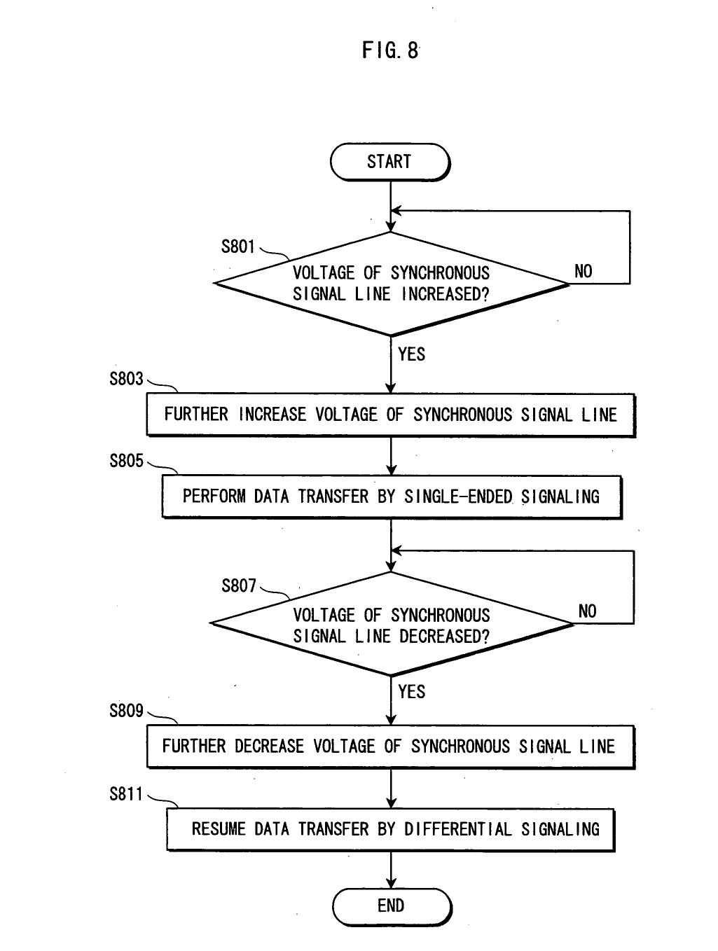

After completing the data transfer by single-ended signaling (step S609), the communication apparatus 400 performs synchronization with the connected device to switch from single-ended signaling back to differential signaling, in order to resume the data transfer by differential signaling (step S611). Details of the switching from differential signaling to single-ended signaling and the switching from single-ended signaling back to differential signaling will be explained later, by referring to a flowchart of FIG. 7 which shows an operation of the communication apparatus 400 and a flow chart of FIG. 8 which shows an operation of the device.

Having switched back to differential signaling, the transceiver 450 has the USB host 410 resume the data generation. The USB host 410 responsively outputs the data retained with respect to the NAK response to the transceiver 450, and also generates subsequent data and outputs them to the transceiver 450. The transceiver 450 retransmits the data which was in the middle of transmission when switching from differential signaling to single-ended signaling, to the connected device (step S613). The transceiver 450 then sequentially transmits the subsequent data generated by the USB host 410 to the connected device. Subsequently, the communication apparatus 400 repeats the above procedure of switching and data transmission each time data is generated by the serial I/O 420.

The following describes a synchronization operation of each of the communication apparatus 400 and the connected device, when switching from differential signaling to single-ended signaling and switching from single-ended signaling back to differential signaling.

The operation of the communication apparatus 400 for synchronizing switching is explained first, with reference to FIG. 7. The synchronization is carried out by setting the potential of the synchronous signal line 431, in the following manner.

When the arbitration circuit 430 outputs a request to switch from differential signaling to single-ended signaling to the transceiver 450, the arbitration circuit 430 increases the voltage of the synchronous signal line 431, which has been set at L (e.g. 100 mV) in differential signaling, to L1 (e.g. 200 mV) (step S701).

Upon detecting that the connected device further increases the voltage of the synchronous signal line 431 to H (e.g. 400 mV) (step S703: YES), the arbitration circuit 430 recognizes that the connected device is ready for data reception by single-ended signaling. Otherwise (step S703: NO), the arbitration circuit 430 waits until the voltage of the synchronous signal line 431 is increased to H. After this, a data transfer by single-ended signaling is performed (step S705).

Once the data transfer by single-ended signaling has completed, single-ended signaling is switched back to differential signaling to resume the data transfer by differential signaling. To do so, the arbitration circuit 430 decreases the voltage of the synchronous signal line 431 which has been set at H, to H1 (e.g. 300 mV) (step S707). When, in response to this, the connected device further decreases the voltage of the synchronous signal line 431 to L (step S709: YES), the arbitration circuit 430 recognizes that the connected device is ready for data reception by differential signaling. Otherwise (step S709: NO), the arbitration circuit 430 waits until the voltage of the synchronous signal line 431 is decreased to L.

The arbitration circuit 430 then outputs a request to switch from single-ended signaling to differential signaling, to the transceiver 450. The transceiver 450 accordingly resumes the transmission of the data generated by the USB host 410 from a point where the data transfer was stopped.

The operation of the connected device for synchronizing switching is explained next, with reference to FIG. 8.

Upon detecting that the communication apparatus 400 increases the voltage of the synchronous signal line 431 to L1 (step S801: YES), an arbitration circuit in the connected device recognizes that the communication apparatus 400 requests to switch from differential signaling to single-ended signaling. The arbitration circuit accordingly outputs a request to switch from differential signaling to single-ended signaling to a transceiver in the connected device. When the transceiver is ready for data reception by single-ended signaling, the arbitration circuit further increases the voltage of the synchronous signal line 431 to H (step S803)

Upon detecting this voltage increase, the communication apparatus 400 starts transmitting data by single-ended signaling, and the connected device receives the data by single-ended signaling (step S805).

After this, upon detecting that the communication apparatus 400 decreases the voltage of the synchronous signal line 431 to H1 (step S807: YES), the arbitration circuit recognizes that the communication apparatus 400 requests to switch from single-ended signaling to differential signaling, and outputs a request to switch from single-ended signaling to differential signaling to the transceiver. When the transceiver is ready for data reception by differential signaling, the arbitration circuit further decreases the voltage of the synchronous signal line 431 to L (step S809), thereby notifying the arbitration circuit 430 in the communication apparatus 400 that the connected device is ready for data reception. Subsequently, the connected device receives data by differential signaling (step S811).

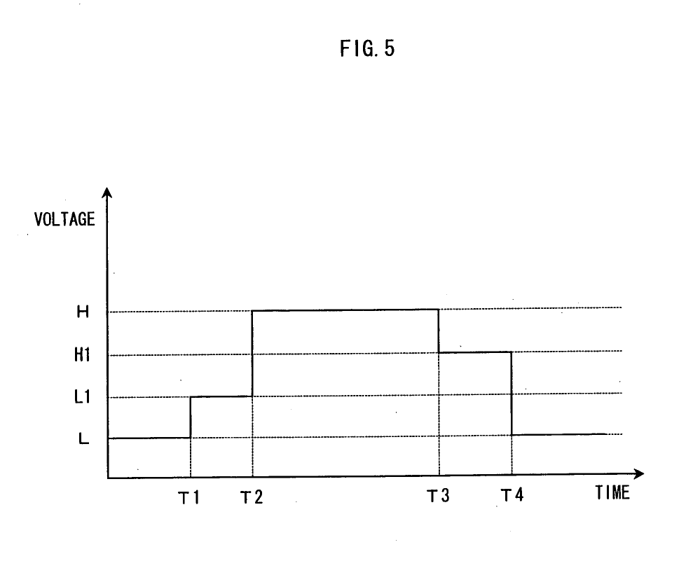

FIG. 5 is a timing graph showing a transition of the potential of the synchronous signal line 431. The above switching is explained using this graph.

At time T1, the arbitration circuit 430 detects the data generation by the serial I/O 420, and increases the potential of the synchronous signal line 431 to L1 as shown in the drawing. The connected device detects this potential increase, and switches from differential signaling to single-ended signaling.

At time T2, the connected device further increases the potential of the synchronous signal line 431 to H. The arbitration circuit 430 detects this potential increase, and requests the transceiver 450 to transmit the data generated by the serial I/O 420. When the data transfer ends during a period from T2 to T3, the arbitration circuit 430 decreases the potential of the synchronous signal line 431 to H1, in order to request the connected device to switch from single-ended signaling back to differential signaling. The connected device detects this potential decrease, switches from single-ended signaling to differential signaling, and further decreases the potential of the synchronous signal line 431 to L at time T4. The arbitration circuit 430 detects this potential decrease to recognize that the connected device is ready for data reception by differential signaling, and resumes the data transfer by differential signaling from a frame that was in the middle of transmission upon the switching to single-ended signaling.

This completes the explanation of the data transfer method switching in the second embodiment.

Modifications

Although the present invention has been described by way of the above first and second embodiments, the present invention should not be limited to the above. Example modifications are given below.

(1) The above embodiments describe the case where the communication apparatuses 100 and 400 each include a USB host, but the communication apparatus may also include a USB device. In this way, the communication apparatus can be connected to another host and operate as a device. The same applies to the communication apparatus 110, which may include not only a USB device but a USB host so as to operate as a host.

(2) The above embodiments describe the case where the communication apparatuses 100 and 400 each request the connected device to switch the data transfer method, but this is not a limit for the present invention. For example, a timer may be provided in each of the communication apparatus and the connected device, so as to switch the data transfer method at predetermined time intervals. In this case, the synchronization is automatically performed between the communication apparatus and the connected device. Since the timing to switch the data transfer method has been determined in advance, there is no need to perform the above synchronization operations. Here, the timer in the communication apparatus and the timer in the connected device are synchronized at the time of initialization.

(3) The above embodiments describe the case where a NAK circuit is used to generate a signal for recognizing connection when switching the data transfer method, but an ACK circuit may instead be used if the completion of the whole data transfer before switching from differential signaling to single-ended signaling can be guaranteed.

(4) The first embodiment describes the case where the communication apparatus 110 includes a storage medium, a CPU, and the like, but these components may be omitted if not necessary. Examples of this modification include a USB mouse and a USB speaker.

(5) The second embodiment describes the case where the communication apparatus 400 sets the potential of the synchronous signal line 431 to L1 when switching from differential signaling to single-ended signaling, and H1 when switching from single-ended signaling to differential signaling. Instead of using the two potentials between H and L, however, one intermediate potential between H and L may be used for switching between differential signaling and single-ended signaling.

(6) The first embodiment describes the case where single-ended signaling uses the D+signal line 120. Alternatively, single-ended signaling may use the D-signal line 121, or use both the D+signal line 120 and the D-signal line 121 to transfer two sets of single-ended signaling data separately.

(7) Each of the functional units described in the above embodiments may be realized as at least part of an LSI (Large Scale Integration), a VLSI (Very Large Scale Integration), or the like, as a plurality of LSIs or the like, or as a combination of at least one LSI or the like and another circuit.

(8) The above embodiments describe an example of the USB 1.1 specification, but the present invention is equally applicable to the USB 2.0 specification. The present invention also includes any communication apparatus that complies with future USB specifications, so long as it has a mechanism of generating a NAK response and having a USB host recognize connection using the NAK response.

The communication apparatus to which the present invention relates can be utilized as a communication apparatus that performs both differential signaling and single-ended signaling using a USB cable.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. A communication apparatus that performs data transfers with an external device-connected thereto by a plurality of signal lines, comprising:
a differential signaling generation unit operable to recognize a predetermined connection state with the external device by receiving a predetermined signal from the external device via two out of the plurality of signal lines, and generate data to be transmitted by differential signaling that uses the two signal lines;
a single-ended signaling generation unit operable to generate data to be transmitted by single-ended signaling that uses one of the two signal lines;
a switching-transmission unit operable to switch a data transfer method between the differential signaling and the single-ended signaling, and transmit a corresponding one of the data generated by the differential signaling generation unit and the data generated by the single-ended signaling generation unit to the external device by the data transfer method; and
a substitute signal output unit operable to, when the switching-transmission unit switches the data transfer method from the differential signaling to the single-ended signaling, output a substitute signal of the predetermined signal to the differential signaling generation unit to have the predetermined connection state recognized.

2. The communication apparatus of claim 1,
wherein the differential signaling generation unit operates in accordance with a USB protocol, and
the substitute signal is a NAK response in the USB protocol.

3. The communication apparatus of claim 1, further comprising:
a reception unit operable to receive data from the external device via the signal line or the two signal lines.

4. The communication apparatus of claim 1,
wherein the switching-transmission unit includes:
a switching signal generation unit operable to generate a switching signal for requesting to switch the data transfer method from the differential signaling to the single-ended signaling; and
a switching signal transmission unit operable to transmit the switching signal to the external device.

5. The communication apparatus of claim 1, further comprising:
a timer unit operable to count a time,
wherein the switching-transmission unit switches the data transfer method whenever a predetermined time is counted by the timer unit.

6. The communication apparatus of claim 1,
wherein the switching-transmission unit includes:
a stop unit operable to, when switching the data transfer method from the differential signaling to the single-ended signaling, have the differential signaling generation unit stop the data generation until the transmission of the data by the single-ended signaling ends.

7. The communication apparatus of claim 2,
wherein if the transmission of the data by the differential signaling is interrupted by switching the data transfer method from the differential signaling to the single-ended signaling, the switching-transmission unit resumes, when switching from the single-ended signaling back to the differential signaling, the transmission of the data by the differential signaling by retransmitting a piece of data which was in a middle of transmission when switching from the differential signaling to the single-ended signaling and for which the NAK response was output.

8. The communication apparatus of claim 1,
wherein the plurality of signal lines include, in addition to the two signal lines, a synchronous signal line for synchronizing the switching of the data transfer method with the external device,
the communication apparatus further comprises:
a setting unit operable to set the synchronous signal line to a first potential, to request the external device to switch the data transfer method; and
a detection unit operable to detect that the external device has switched the data transfer method and is ready for data reception by the data transfer method, when the first potential of the synchronous signal line is changed to a second potential by the external device, and
the switching-transmission unit switches the data transfer method and transmits the corresponding data to the external device, after the detection unit detects that the external device has switched the data transfer method and is ready for data reception by the data transfer method.

9. A switching method used in a communication apparatus to switch a data transfer method, comprising:
a differential signaling generation step of recognizing a predetermined connection state with an external device connected to the communication apparatus by receiving a predetermined signal from the external device via two signal lines, and generating data to be transmitted by differential signaling that uses the two signal lines;
a single-ended signaling generation step of generating data to be transmitted by single-ended signaling that uses one of the two signal lines;
a switching-transmission step of switching the data transfer method between the differential signaling and the single-ended signaling, and transmitting a corresponding one of the data generated in the differential signaling generation step and the data generated in the single-ended signaling generation step to the external device by the data transfer method; and
a substitute signal generation step of, when the switching-transmission step switches the data transfer method from the differential signaling to the single-ended signaling, generating a substitute signal of the predetermined signal to have the predetermined connection state recognized.

10. A switching program used in a computer of a communication apparatus to execute a process of switching a data transfer method, the process comprising:
a differential signaling generation step of recognizing a predetermined connection state with an external device connected to the communication apparatus by receiving a predetermined signal from the external device via two signal lines, and generating data to be transmitted by differential signaling that uses the two signal lines;
a single-ended signaling generation step of generating data to be transmitted by single-ended signaling that uses one of the two signal lines;
a switching-transmission step of switching the data transfer method between the differential signaling and the single-ended signaling, and transmitting a corresponding one of the data generated in the differential signaling generation step and the data generated in the single-ended signaling generation step to the external device by the data transfer method; and
a substitute signal generation step of, when the switching-transmission step switches the data transfer method from the differential signaling to the single-ended signaling, generating a substitute signal of the predetermined signal to have the predetermined connection state recognized.
